(19) United States
(12) Patent Application Publication
(10) Pub. No.: US 2022/0303840 A1
(43) Pub. Date: Sep. 22, 2022

(54) CELL HANDOVER METHOD AND USER EQUIPMENT

(71) Applicant: SHARP KABUSHIKI KAISHA, Sakai City, Osaka (JP)

(72) Inventors: NINGJUAN CHANG, Shanghai (CN); CHAO LUO, Shanghai (CN); RENMAO LIU, Shanghai (CN)

(21) Appl. No.: 17/634,393

(22) PCT Filed: Aug. 14, 2020
(86) PCT No.: PCT/CN2020/109233

§ 371 Date: Feb. 10, 2022

(30) Foreign Application Priority Data
Aug. 14, 2019 (CN) 201910752418.0

(51) Int. Cl. H04W 36/00; H04W 36/08

(52) U.S. Cl. CPC H04W 36/0072; H04W 36/08

(57) ABSTRACT

Provided in the present invention are a cell handover method and user equipment. The cell handover method comprises: the UE receiving a handover command for instructing the UE to perform an enhanced handover mechanism; performing, on the basis of a Radio Resource Control (RRC) configuration included in the handover command, RRC configuration operations corresponding to communication between the UE and a source cell and communication between the UE and a target cell; the UE performing access to the target base station while maintaining a data transmission connection to the source base station; and the UE performing an uplink path switching operation on a data radio bearer (DRB) configured with the enhanced handover mechanism, and switching an uplink transmission path from the source cell to the target cell for the DRB.

### TECHNICAL FIELD

The present disclosure relates to the technical field of wireless communications. More specifically, the present disclosure relates to a cell handover method and corresponding user equipment.

### BACKGROUND

A new research project on 5G technical standards (see non-patent literature: RP-181433: New WID on NR (New Radio) mobility enhancements) and a new research project on Long Term Evolution (LTE) system Release 16 (see non-patent literature: RP-181544) were approved at the 3rd Generation Partnership Project (3GPP) RAN #80 plenary meeting in June 2018. One of the research goals of these two projects is to find a solution to meet one of mobility requirements: seamless handover, i.e., allowing handover interruption time of zero milliseconds or near-zero milliseconds during a handover procedure of changing a serving cell of UE. Among solutions under investigation to reduce handover interruption time, one solution is an enhanced Make Before Break (MBB) mechanism. In the enhanced MBB mechanism, after receiving a handover command, UE does not cut off a link (data transmission) to a source base station in a handover procedure to access a target base station, but rather, the UE can maintain links to the target base station and the source base station at the same time, thereby avoiding a delay caused by service interruption due to disconnection to the source base station before accessing the target base station.

The present disclosure provides a solution to the issue of how to implement an enhanced MBB mechanism in an LTE system or an NR system.

### SUMMARY OF INVENTION

An objective of embodiments of the present disclosure is to provide a solution to the issue of implementing an enhanced MBB technology in an LTE/NR system. More specifically, the present disclosure proposes a solution to the issue of how to switch an uplink path from a source cell to a target cell during a random access procedure of UE to a target base station or after the random access procedure is completed in an LTE/NR system. Provided in the embodiments of the present disclosure are a cell handover method in user equipment and corresponding user equipment.

According to a first aspect of the present disclosure, provided is a cell handover method, comprising: the UE receiving a handover command for instructing the UE to perform an enhanced handover mechanism; performing, on the basis of a Radio Resource Control (RRC) configuration included in the handover command, RRC configuration operations corresponding to communication between the UE and a source cell and communication between the UE and a target cell; the UE performing access to the target base station while maintaining a data transmission connection to the source base station; and the UE performing an uplink path switching operation on a data radio bearer (DRB) configured with the enhanced handover mechanism, and switching an uplink transmission path DRB from the source cell to the target cell for the DRB.

In the foregoing cell handover method, the RRC configuration operation may comprise at least one of the following operations: establishing a MAC entity for the target cell; establishing a physical layer entity for the target cell; deriving a key for the communication with the target cell, and configuring a lower layer to apply the derived key to all subsequent messages and data communicated with the target cell; and generating an RRC connection reconfiguration complete message, and delivering the RRC connection reconfiguration complete message to a lower layer corresponding to the target cell for transmission.

In the foregoing cell handover method, a system-defined default configuration may be applied to the MAC entity and the physical layer entity.

In the foregoing cell handover method, in the RRC configuration operation, when an information element for configuring a radio bearer comprises a DRB addition/modification list, at least one of the following operations may be performed on a DRB configured with the enhanced handover mechanism in the DRB addition/modification list: reconfiguring a Packet Data Convergence Protocol (PDCP) entity according to a received PDCP configuration; establishing a Radio Link Control (RLC) entity corresponding to the target cell, and reconfiguring the RLC entity according to a received RLC configuration; establishing a dedicated traffic channel (DTCH) logical channel, and reconfiguring the DTCH according to a received logical channel configuration; and if a DRB identity is part of the current UE configuration or the UE has been configured with a DRB having the same evolved package system (EPS) bearer identity, associating, by the UE, the established DRB corresponding to the target cell with a DRB corresponding to the source cell having the same DRB identity or a DRB corresponding to the source cell having the same EPS bearer identity.

In the foregoing cell handover method, the uplink path switching operation may comprise at least one of the following operations: operation 1: an RRC layer of the UE transmits an uplink path switching instruction to a lower layer; operation 2: the RRC layer of the UE instructs the lower layer to suspend an uplink operation of the DRB configured with the enhanced handover mechanism; operation 3: the RRC layer of the UE configures the lower layer to suspend an encryption or integrity protection function for security processing of uplink data that uses a secret key related to the source cell; operation 4: a MAC layer of the UE considers that an available data amount of an RLC and/or PDCP entity for calculating a buffer status in a layer-2 uplink data buffer is zero; operation 5: the MAC layer or a physical layer of the UE discards an uplink grant from the source cell or a physical downlink control channel (PDCCH) for scheduling uplink transmission that comprises the uplink grant; and operation 6: the UE activates a DRB for communication with the target cell, i.e., DRB-target, that corresponds to the DRB configured with the enhanced handover mechanism.

In the foregoing cell handover method, the RRC layer of the UE may perform the operations upon receiving instruction information from the MAC layer for instructing uplink path switching.

In the foregoing cell handover method, the uplink path switching operation may further comprises the following operation: operation 7: the RRC layer of the UE instructs a PDCP layer to perform a PDCP data recovery operation.

In the foregoing cell handover method, after receiving the instruction from the RRC layer in operation 1, operation 2, or operation 7, the PDCP layer may perform the PDCP data recovery operation, and the PDCP data recovery operation comprises: operation 1: for a DRB mapped to an RLC non-acknowledge mode, the PDCP layer considers that all PDCP packet data units (PDUs) are received from the upper layer, and performs, for all PDCP service data units (SDUs), transmission of the PDCP SDUs in ascending order of count values associated therewith before the PDCP data recovery operation is performed; and operation 2: for a DRB mapped to an RLC acknowledge mode, the PDCP layer performs, starting from the first PDCP SDU that has not been confirmed to be successfully delivered, retransmission of all PDCP SDUs in ascending order of count values associated therewith before the PDCP data recovery operation is performed.

In the foregoing cell handover method, after the uplink path switching operation is triggered, if the UE has a limited transmission capability, the UE performs uplink transmission to the target cell in priority to uplink transmission to the source cell.

According to a second aspect of the present invention, provided is user equipment, comprising: a processor; and a memory storing instructions, wherein the instructions, when run by the processor, perform the control method for user equipment described herein.

### BRIEF DESCRIPTION OF THE DRAWINGS

In order to understand the present disclosure and advantages thereof more fully, reference will now be made to the following description made in conjunction with the accompanying drawings.

FIG. 1 is a sequence diagram showing that user equipment (UE) in a connected state changes a serving cell by means of a handover procedure.

FIG. 2 is a flowchart showing an example of a cell handover method of the present invention.

FIG. 3 is a block diagram showing the user equipment (UE) involved in the present invention.

In the drawings, identical or similar structures are marked by identical or similar reference numerals.

### DETAILED DESCRIPTION

According to the following detailed description of exemplary embodiments of the present disclosure made in conjunction with the accompanying drawings, other aspects, advantages, and prominent features of the present disclosure will become apparent to those skilled in the art.

In the present disclosure, the terms “include” and “comprise” and derivatives thereof mean inclusion without limitation; the term “or” may have an inclusive meaning and means “and/or”.

In the present specification, the following various embodiments for describing the principles of the present disclosure are merely illustrative, and should not be interpreted in any way as limiting the scope of the disclosure. The following description with reference to the accompanying drawings is used to facilitate full understanding of the exemplary embodiments of the present disclosure defined by the claims and equivalents thereof. The following description includes a variety of specific details to facilitate understanding, but these details should be considered merely exemplary. Therefore, those of ordinary skill in the art should recognize that various changes and modifications may be made to the embodiments described herein without departing from the scope and spirit of the present disclosure. In addition, the description of the known function and structure is omitted for clarity and simplicity. In addition, the same reference numerals are used for similar functions and operations throughout the accompanying drawings.

A plurality of embodiments according to the present disclosure are specifically described below by using a Long Term Evolution (LTE)/NR mobile communication system and subsequent evolved versions thereof as an exemplary application environment. However, it is to be noted that the present disclosure is not limited to the following embodiments, but may be applied to other wireless communications systems. In the present disclosure, unless otherwise specified, the concept of a cell and the concept of a base station are interchangeable. An LTE system may also refer to a 5G LTE system and a post-5G LTE system (such as an LTE system referred to as an eLTE system or an LTE system that can be connected to a 5G core network). In addition, the LTE can be replaced with an evolved universal terrestrial radio access (E-UTRA) or an evolved universal terrestrial radio access network (E-UTRAN). In the present disclosure, a handover refers to change of a primary cell initiated by a network side, including inter-cell change of a primary cell and intra-cell change of a primary cell. That is, a primary cell of UE is changed from a source cell to a target cell, where the source cell and the target cell may be the same cell or different cells. In this procedure, a secret key or a security algorithm for access layer security may also be updated accordingly. The source cell may also be referred to as a source base station, or may also be a source beam or a source transmission point (TRP). The target cell may also be referred to as a target base station, or may also be a target beam or a target transmission point. The source cell refers to a connected cell serving the UE before a handover procedure is initiated, namely, a cell transmitting to the UE a Radio Resource Control (RRC) message including a handover command. The target cell refers to a cell connected to and serving the UE after the handover procedure is successfully completed, or a cell indicated by a target cell identity included in the handover command. The handover command described in the present disclosure is used to trigger the UE to execute a handover. In an NR system, the handover command is an RRC reconfiguration message including a synchronized reconfiguration (Reconfigurationwithsync) information element, or rather, the handover command is an RRC reconfiguration message including a synchronized reconfiguration (Reconfigurationwithsync) information element for a master cell group (MCG). At this time, a handover may also be referred to as synchronous reconfiguration. In an LTE system, the handover command is an RRC connection reconfiguration message including a mobility control information (MobilityControlInformation) information element. The synchronized reconfiguration information element or the mobility control information information element includes configuration information of the target cell, for example, a target cell identity, a target cell frequency, common configurations of the target cell such as system information, a random access configuration used by the UE to access the target cell, a security parameter configuration of the UE in the target cell, a radio bearer configuration of the UE in the target cell, etc. For simplicity of description, in the present disclosure, the RRC reconfiguration message is equivalent to the RRC connection reconfiguration message; similarly, an RRC reconfiguration complete message serving as a response message thereto is equivalent to an RRC connection reconfiguration complete message. The handover command is equivalent to the RRC message including the handover command, and refers to an RRC message or a configuration in the RRC message triggering the UE to execute a handover. The handover configuration refers to all of or part of configurations in the handover command. “Cancel”, “release”, “delete”, “flush”, and “clear” are interchangeable. “Execute”, “use”, and “apply” are interchangeable. “Configure” and “reconfigure” are interchangeable. “Monitor” and “detect” are interchangeable.

Contents contained in the handover command are introduced first. In an LTE system, an RRC connection reconfiguration message for a handover command carries RRC configurations from a target base station, including but not limited to the following RRC configurations (see Section 6.2.2 of 3GPP Technical Standard Protocol 36.331 for details):
A measurement configuration (measconfig information element): used to configure intra-frequency, inter-frequency, and inter-radio access technology measurements performed by UE, for example, a measurement object configuration, a measurement report configuration, a measurement gap configuration, etc.
Mobility control information (mobilitycontrolInfo information element): as previously described, basic information to be acquired by the UE to access the target base station in configuring network-side-controlled mobility, including a target cell identity, a target carrier frequency, a carrier band block corresponding to the target cell, a timer T304 configuration, a cell-radio network temporary identifier (C-RNTI) used by the UE in the target cell, radio resource configuration common information (RadioresourceconfigCommon information element), a random access dedicated configuration (rach-configDedicated), a RACH-less access indication, MBB enabling information, V2X information, etc.
Non-access stratum dedicated information (dedicatedInfoNASList information element).
Radio resource configuration dedicated information (radioresourceConfigDedicated information element), used to establish or modify or release a radio bearer, or modify a MAC configuration or a physical layer dedicated configuration, etc., including a signaling radio bearer (SRB) addition/modification list, an SRB release list, a data radio bearer (DRB) addition/modification list, a DRB release list, a MAC main configuration (indicated by a MAC-mainconfig information element), a physical layer dedicated configuration, a semi-persistent scheduling configuration, a radio link failure related timer, and a constant configuration.
A handover security configuration (securityconfigHO information element)
Secondary cell configuration information (a secondary cell addition/deletion list and/or a secondary cell release list)
Other configurations (otherconfig information element), used to configure a proximity report configuration (reportproximityconfig information element)), an In-Device Coexistence (IDC) configuration, a power preference indication configuration (powerprefIndicationconfig information element), a location obtaining configuration (obtainlocationconfig Information Element), etc.
An LTE-WLAN Aggregation (LWA) configuration.
An LTE-WLAN Radio Level Integration with IPsec Tunnel (LWIP) configuration.
A Radio Controlled LTE-WLAN Integration (RCLWI) configuration.
A sidelink communication configuration (sidelink related configuration).

In an NR system, an RRC reconfiguration message for a handover command carries RRC configurations from a target base station, including but not limited to the following RRC configurations (see Section 6.2.2 of 3GPP Technical Standard Protocol 38.331 for details):
A measurement configuration (measconfig information element): used to configure intra-frequency, inter-frequency, and inter-radio access technology measurements performed by UE, for example, a measurement object configuration, a measurement report configuration, a measurement gap configuration, etc.
A cell group configuration (cellGroupConfig information element), used to configure a master cell group or a secondary cell group, including an RLC bearer configuration (rlc-bearerToAddModList information element and rlc-bearerToreleaselist information element), a MAC configuration (MAC-cellgroupconfig information element), a physical layer configuration, a secondary cell addition/modification/release configuration, a special cell (SpCell) configuration corresponding to a DRB/SRB, etc. The spcell configuration includes a cell index number, handover information (reconfigurationWithSync information element), a radio link failure related timer and constant configuration, a Radio Link Monitoring (RLM) configuration, a special cell dedicated configuration, etc. The reconfigurationwithsync information element is similar to the mobility control information in the LTE system and includes handover related information to implement mobility, and the information element includes serving cell configuration common information, a C-RNTI of the UE in the target cell, a handover related timer T304 configuration, a random access dedicated configuration for a random access procedure to the target cell.
Non-access stratum dedicated information (dedicatedInfoNASList information element).
A radio bearer configuration (radiobearerConfig information element), used to add, modify, or release an SRB or a DRB, including a Service Data Application Protocol (SDAP) layer and a Packet Data Convergence Protocol (PDCP) for configuring a radio bearer DRB and/or SRB.
A master key update configuration (masterKeyupdate information element).
Other configurations (otherconfig information element), used to configure a proximity report configuration (reportproximityconfig information element)), an In-Device Coexistence (IDC) configuration, a power preference indication configuration (powerprefIndicationconfig information element), a location obtaining configuration (obtainlocationconfig Information Element), etc.

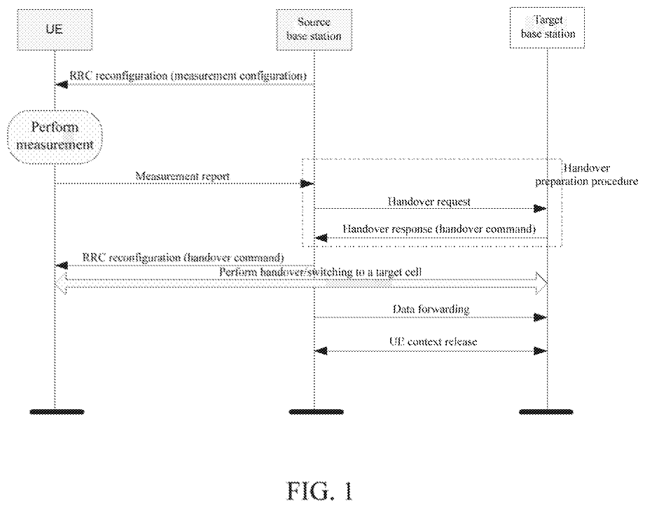

A general handover procedure in an LTE/NR system is briefly described below. FIG. 1 is a sequence diagram showing that user equipment (UE) in a connected state changes a serving cell through a handover procedure. Referring to FIG. 1, the procedure is briefly described as follows:

Phase 1: A base station delivers a measurement configuration to user equipment (UE); the UE performs, on the basis of the measurement configuration, measurement on a radio link corresponding to a serving cell; and when a configured reporting condition is met, the UE transmits a measurement report to the base station. The base station determines, according to the received measurement report and other factors such as the payload of the base station, whether to hand over the UE.

Phase 2: If a handover is determined, then the source base station triggers a handover preparation procedure to transmit a handover request message to a target base station; the target base station determines, according to factors such as a context of the UE in the handover request message and available resources of the target base station, whether to accept the UE, and if so, then feeds back a handover acknowledgment message to the source base station, where the handover acknowledgment message includes a handover command for transmitting to the UE to instruct the UE to perform a handover.

Phase 3: The source base station delivers the handover command to the UE, and starts to forward data to the target base station. The UE receiving the handover command immediately executes the handover command, applies a Radio Resource Control (RRC) configuration in the handover command, disconnects from the source base station, and starts to access the target base station, for example, accesses the target base station through a random access procedure.

An MBB mechanism is introduced into a Release 14 LTE system in this phase. That is, the UE can still maintain communication with the source base station after receiving the handover command and before starting to access the target base station (for example, before transmitting an access preamble to the target base station to initiate a random access procedure), and disconnect from the source base station only after starting to access the target base station (for example, after transmitting the access preamble to the target base station to initiate the random access procedure). The MBB mechanism may reduce handover interruption time to some extent.

Phase 4: After confirming a successful access by the UE, the target base station transmits a handover complete message to the source base station. Based on the handover complete message, the source base station discards the UE context stored thereon.

It can be seen from the above that the handover procedure in the LTE system causes interruption of data transmission. Even if the MBB mechanism is employed during the handover procedure, after attempting to access the target base station and before starting data communication with the target base station when the access succeeds, the UE is still in a procedure involving no data communication with the network side, and transmission of user data cannot be performed during this period of time. In LTE systems of subsequent releases, optimization of a handover procedure such as a handover without a random access procedure aims to reduce handover delays and overheads, and can also bring decreases in data interruption time during the handover procedure, but still fails to meet requirements of “zero milliseconds” or “near zero milliseconds” data interruption time.

In technical requirements of 5G NR and Release 16 LTE systems, it is required to meet the data interruption time of “zero milliseconds” as much as possible in a mobile handover procedure so as to meet the mobility requirements of seamless handover. In view of the cause of the above data interruption during the handover procedure, a feasible enhanced handover method is that the UE maintains communication with the source base station and also accesses the target base station during the handover procedure. That is, the UE maintains communication with both the source base station and the target base station at the same time during the handover procedure. Within a period of time, the UE can perform data transmission with the source base station and can also perform data transmission with the target base station, and a connection to the source base station is released after a successful handover to the target base station, so that data interruption time of “zero milliseconds” is achieved in this manner. This requires the UE to have independent Medium Access Control (MAC) layer (MAC-source and MAC-target) and Physical Layer (PHY-source and PHY-target) processing for both the source base station and the target base station. For a Data Radio Bearer (DRB), in order to communicate with the two base stations during the handover procedure, the UE needs to have a data radio bearer with the source base station (referred to as DRB-source) and a radio bearer with the target base station (referred to as DRB-target). A protocol stack on the UE side as an example is used as an example. At present, the 3GPP has reached a conclusion to use the following protocol stack structure to implement a DRB with dual protocol stacks: the DRB-source and the DRB-target respectively include independent Radio Link Control (RLC) layers (which may be referred to as RLC-source and RLC-target), but share the same PDCP. Inside the PDCP, however, some functional entities are separate for the DRB-source and the DRB-target, whereas some functional entities are common for the DRB-source and the DRB-target. For example, at the PDCP layer, security processing is separately performed for the DRB-source and the DRB-target by using different security keys, and a robust header compression (ROHC) function for packet (de)compression may be separately implemented for the DRB-source and the DRB-target by using different ROHC configurations. A packet sequence number of the PDCP layer is uniformly allocated to the DRB-target. For a downlink, a shared reordering function is used in the PDCP, and data processed by a shared functional entity will be delivered to an upper layer in order. The security processing includes encryption (decryption) and/or integrity protection verification; the security key includes an encryption/decryption key and/or integrity protection verification key. According to the structure of the protocol stack, the aforementioned MAC, RLC, and PDCP are also called layer 2, and the physical layer is also called layer 1.

For the aforementioned eMBB handover method that simultaneously maintains data transmission connections to the source base station and the target base station during the handover procedure, the present disclosure does not limit the nomenclature thereof, which may also be referred to as DC-based handover, non-split bearer handover, and split bearer handover.

In the current 3GPP discussion, in consideration of requirements and limitations of UE capabilities, in an eMBB handover procedure, simultaneous reception of downlink data from the source cell and the target cell is supported, while for an uplink, it is unnecessary to support simultaneous transmission of a physical uplink shared channel (PUSCH) to the source cell and the target cell. That is to say, the UE can only transmit the PUSCH to one serving cell (source cell or target cell) at the same time. In the handover procedure, the UE maintains an uplink path to the source cell before a time point and transmits a PUSCH to the source cell, and after this time point, the UE maintains an uplink path to the target cell and transmits a PUSCH to the target cell. How to implement the switching between the above uplink paths becomes an issue to be solved by the present disclosure. The following implementation methods provided in the present disclosure enable the UE to implement the switching from the uplink path to the source cell to the uplink path to the target cell during the eMBB handover procedure, and reduce a handover interruption delay and a packet loss rate.

Hereinafter, specific examples and embodiments related to the present invention are described in detail. In addition, as described above, the examples and embodiments described in the present disclosure are illustrative descriptions for facilitating understanding of the present invention, rather than limiting the present invention. In addition, the technical solution obtained by appropriately changing, combining and replacing the embodiments recorded below should be also included in the scope of the present invention.

### Embodiment 1

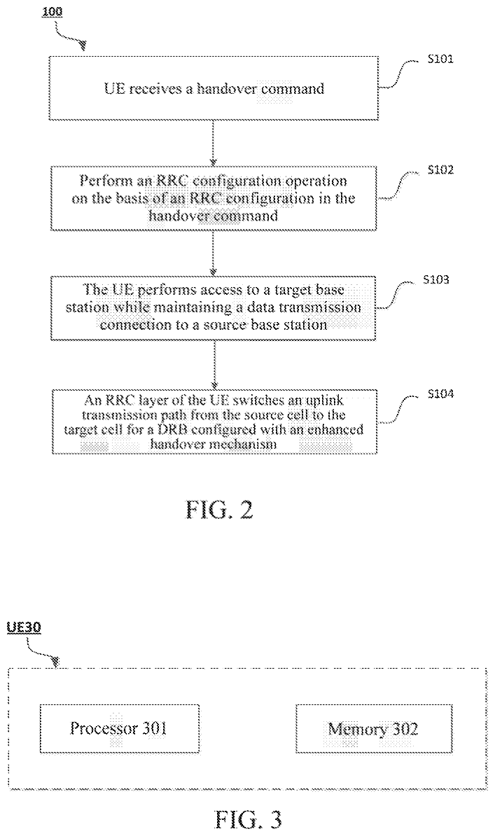

Embodiment 1 of the present invention will be described in detail below. This embodiment provides a method for switching an uplink path of UE in an enhanced handover mechanism (eMBB). FIG. 2 is a flowchart showing an example of a cell handover method of the present invention. As shown in FIG. 2, the cell handover method includes:

Step S101: The UE receives a handover command (RRC reconfiguration message). The handover command instructs the UE to perform an enhanced handover mechanism, for example, the handover command includes an enhanced handover mechanism indication. Alternatively, the enhanced handover mechanism indication may also be separately configured for each DRB, that is, each DRB may correspond to one enhanced handover mechanism indication. In this case, a DRB-related operation in the following step is performed on only a DRB configured with an enhanced handover mechanism indication.

Step S102: Perform an RRC configuration operation on the basis of an RRC configuration in the handover command, including one or a plurality of the following:
Establish a MAC entity (i.e., MAC-target) for a target base station. Preferably, a system-defined default configuration is applied to the MAC entity. Alternatively, the MAC entity is configured according to a MAC configuration (corresponding to a MAC main configuration information element (MAC-MainConfig) in LTE or corresponding to a MAC cell group configuration information element (MAC-CellGroupConfig) in NR) in the received RRC connection reconfiguration message.
Establish a physical layer entity (i.e., PHY-target) for the target base station. Preferably, a system-defined default configuration is applied to the physical layer entity. Alternatively, the physical layer entity is configured according to a physical layer configuration dedicated information element (physicalConfigDeadicated) in the received RRC connection reconfiguration message.
Derive a key for communication with the target base station, and configure a lower layer (PDCP) to apply the derived key (K_{RRCint}, K_{RRCenc}, and K_{UPenc}) to all subsequent messages/data communicated with the target base station (received from and transmitted to the target base station).
If an information element for configuring a DRB (corresponding to a radio resource configuration dedicated information element RadioResourceConfigDedicated in LTE, or corresponding to a radio bearer configuration information element RadioBearerConfig in NR) includes a DRB addition/modification list, perform one or a combination of a plurality of the following on a DRB configured with the enhanced handover mechanism in the DRB addition/modification list:
   Reconfigure a PDCP entity according to a received PDCP configuration. The reconfiguring the PDCP entity includes establishing in the PDCP entity a corresponding functional entity such as a security function or a header compression processing function, etc., for the target base station (or described as activating/enabling a function corresponding to the target base station in the PDCP entity).
   Establish an RLC entity (i.e., RLC-target) and reconfigure the RLC entity according to a received RLC configuration.
   Establish a dedicated traffic channel (DTCH) logical channel and reconfigure the DTCH according to a received logical channel configuration.
   If the DRB identity is part of the current UE configuration or the UE has been configured with a DRB having the same evolved packet service (EPS) bearer identity, then the UE associates the established DRB (i.e., DRB-target) with a DRB (DRB-target) having the same DRB identity or a DRB (DRB-target) having the same EPS bearer identity.
Generate an RRC connection reconfiguration complete message, and deliver the message to a lower layer corresponding to the target base station for transmission. The lower layer includes PDCP, RLC, MAC, and physical layers.

By this step, the UE maintains two sets of RRC configurations: one set corresponds to the source base station for communication between the UE and the source base station; and the other set corresponds to the target base station for communication between the UE and the target base station.

Step S103: The UE performs access to the target base station while maintaining a data transmission connection to the source base station. In a handover procedure including a random access procedure, the performing the access to the target base station refers to performing a random access procedure to the target base station, such as transmitting a random access preamble to the target base station.

Step S104: An RRC layer of the UE switches an uplink transmission path from the source cell to the target cell for the DRB(s) configured with the enhanced handover mechanism. The uplink path switching includes one or a plurality of the following operations:

Operation 1: The RRC layer transmits an uplink path switching instruction to the lower layer. The operation may also be expressed as the RRC layer configuring the lower layer to switch the uplink path.

Operation 2: The RRC layer instructs the lower layer to suspend an uplink operation of the DRB. The uplink operation refers to an operation on a transmitting side of an L2 and/or L1 entity associated with the DRB. The lower layer refers to the L2 or L1 entity corresponding to the DRB, preferably, refers to the PDCP or RLC layer corresponding to the DRB. By this operation, the PDCP/RLC layer no longer processes transmission of an uplink data packet associated with the source cell.

Operation 3: The RRC layer configures the lower layer to suspend an encryption or integrity protection function for security processing of uplink data that uses a secret key related to the source cell. The secret key includes K_{UPenc} for uplink data encryption or K_{RRCint} (or K_{UPint}) for integrity protection. The lower layer is the PDCP layer. The secret key related to the source cell refers to a secret key used by the UE before performing the handover procedure, i.e., before receiving the handover command.

Operation 4: A MAC layer of the UE considers that an available data amount of an RLC and/or PDCP entity for calculating a buffer status in an L2 uplink data buffer is zero.

Operation 5: The MAC layer or a physical layer of the UE ignores an uplink grant from the source cell or a PDCCH for scheduling uplink transmission that includes the uplink grant. The PDCCH from the source cell refers to a PDCCH scrambled with a UE radio network identity used by the UE in the source cell (for example, a C-RNTI used by the UE in the source cell before the handover). Optionally, this operation is performed when the MAC/physical layer of the UE receives the instruction or configuration from the RRC layer in operation 1 above.

Operation 6: The UE activates the DRB-target corresponding to the DRB configured with the enhanced handover mechanism, that is, activates the DRB-target established in step S102.

In step S104, preferably, the RRC layer of the UE performs the aforementioned operations upon receiving instruction information from the MAC layer for instructing uplink path switching. Preferably, the MAC layer of the UE indicates the aforementioned instruction information to the RRC layer when receiving the first uplink grant from the target base station. In this case, the instruction information may be referred to as a first uplink grant successful reception indication. The uplink grant includes resource allocation for uplink transmission. In a handover with a random access procedure, the first uplink grant is included in a random access response message, and the random access response refers to a random access response that includes a random access preamble identifier corresponding to a random access preamble transmitted by the UE in the random access procedure. Alternatively, in a handover without a random access procedure (RACH-less), the first uplink grant received by the MAC means that the MAC layer successfully receives from the target base station physical downlink control channel (PDCCH) transmission for scheduling a PUSCH, which is identified by a radio network temporary identifier (such as a cell-radio network temporary identifier (C-RNTI)) and includes a UL grant.

Alternatively, the MAC layer of the UE indicates the above instruction information to the RRC layer upon successfully completing the random access procedure. When the random access procedure is a non-contention-based random access procedure (i.e., the random access preamble is a dedicated resource specified in the handover command), the successful completion of the random access procedure means that the UE receives a random access response message that includes a random access preamble identifier corresponding to a random access preamble transmitted thereby. When the random access procedure is a contention-based random access procedure (i.e., the random access preamble is selected by the MAC layer itself), the successful completion of the random access procedure means that the UE receives PDCCH transmission addressed by the C-RNTI thereof and the PDCCH includes an uplink grant for new transmission.

Unless otherwise specified, the L2 entity in step S104 in this embodiment refers to an L2 entity associated with the source cell.

### Embodiment 2

Embodiment 2 of the present invention will be described below. This embodiment provides a method for switching an uplink path of UE in an enhanced handover mechanism (eMBB). This embodiment can be used as a supplement to Embodiment 1, and can also be executed in parallel with Embodiment 1. Through operations of a PDCP layer described in this embodiment, the loss of data packets can be reduced, and the packet loss rate during a handover procedure can be reduced.

Step S101 to step S104 are the same as those in Embodiment 1, and will not be repeated herein.

In addition, step S104 may further include:

Operation 7: The RRC layer instructs the PDCP layer to perform a PDCP data recovery operation.

Step S105: Upon receiving the instruction/request from the RRC layer in operation 1 or operation 2 or operation 7 in step S104, the PDCP layer performs a PDCP data recovery operation/procedure, including:

Operation 1: For a DRB mapped to an RLC unacknowledge mode (UM), the PDCP layer considers that all PDCP packet data units (PDUs) are received from the upper layer, and performs, for all PDCP service data units (SDUs), transmission of these PDCP SDUs in ascending order of count values associated therewith prior to step S105. The PDCP PDU in this operation includes a PDCP PDU that has been transmitted to the lower layer for transmission. In this operation, the operation of the PDCP layer considering that all the PDCP PDUs are received from the upper layer allows the PDCP layer to re-process a data packet that has been processed by the PDCP layer (such as header compression using an ROHC configuration of the PDCP layer of the source cell or encryption processing using a security key associated with the source cell) as a PDCP SDU just received from the upper layer according to a PDCP configuration (such as an ROHC configuration or a security key) corresponding to the target cell, so that the data packet can be transmitted through a target cell path.

Operation 2: For a DRB mapped to an RLC acknowledge mode (AM), the PDCP layer performs, starting from the first PDCP SDU that has not been confirmed to be successfully delivered, retransmission of all PDCP SDUs in ascending order of count values associated therewith prior to step S105.

The count value refers to a COUNT value of the PDCP layer, which is used for an encryption or integrity check function, and consists of a hyper frame number (HFN) and a PDCP sequence number (SN).

### Embodiment 3

Embodiment 3 of the present invention will be described below. In an implementation, the uplink path switching in the foregoing embodiments does not include a link state indication (CSI) report used to feed back downlink quality, or a hybrid automatic repeat request (HARQ) feedback used to confirm whether downlink data is correctly received, or uplink HARQ retransmission data for which HARQ acknowledgement feedback (ACK) has not been received before uplink path switching. That is to say, the CSI report, or the HARQ feedback, or the HARQ retransmission data related to the source cell link may still be transmitted by the UE to the source cell after the uplink path switching. However, due to restrictions of the capabilities of the UE, for example, the UE has only one transmitter or the UE has insufficient uplink transmission power, when uplink transmission needs to be performed on an uplink of the source cell and an uplink of the target cell at the same time, the UE cannot complete the transmission. With the method described in this embodiment, in such a case, the UE performs uplink transmission by means of priority processing, thereby ensuring link connection and service quality to the greatest extent.

In this embodiment 3, for UE configured with an enhanced handover indication, after uplink path switching is triggered, if the UE has limited transmission capabilities, the UE performs uplink transmission to the target cell in specified time in priority to uplink transmission to the source cell.

The trigger of the uplink path switching is, as described in the foregoing embodiments, preferably, that the UE receives the first uplink grant included in an RAR or scheduled through a PDCCH from the target base station. Alternatively, it is the UE that receives uplink path switching instruction information from the upper layer.

### Embodiment 4

In this embodiment, the user equipment according to the present disclosure is described. FIG. 3 is a block diagram showing the user equipment (UE) involved in the present invention. As shown in FIG. 3, the UE 30 includes a processor 301 and a memory 302. The processor 301 may include, for example, a microprocessor, a microcontroller, an embedded processor, and the like. The memory 302 may include, for example, a volatile memory (for example, a random access memory (RAM)), a hard disk drive (HDD), a non-volatile memory (for example, a flash memory), or other memories. The memory 302 stores program instructions. When run by the processor 301, the instructions can perform the foregoing handover method described in detail in the present invention.

The methods and related devices according to the present disclosure have been described above in conjunction with preferred embodiments. It should be understood by those skilled in the art that the methods shown above are only exemplary. The method according to the present disclosure is not limited to steps or sequences shown above. The base station and user equipment shown above may include more modules. For example, the base station and user equipment may further include modules that may be developed or will be developed in the future to be applied to a base station, an MME, or UE. Various identifiers shown above are only exemplary, not for limitation, and the present disclosure is not limited to specific information elements serving as examples of these identifiers. Those skilled in the art can make various alterations and modifications according to the teachings of the illustrated embodiments.

The program running on the device according to the present disclosure may be a program that enables a computer to implement the functions of the embodiments of the present disclosure by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present disclosure may be recorded on a computer-readable recording medium. The corresponding functions may be achieved by reading programs recorded on the recording medium and executing them by the computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the described embodiments have been described, the present disclosure is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications may be made to the present disclosure within the scope of the claims. Embodiments resulted from the appropriate combinations of the technical means disclosed in different embodiments are also included within the technical scope of the present disclosure. In addition, components with the same effect described in the above embodiments may be replaced with one another.

1. A User Equipment (UE), comprising a processor and a memory in electronic communication with the processor, wherein instructions stored in the memory are executable to, the processor being configured to:
receive an RRC reconfiguration message for instructing an enhanced handover indicating a configuration for a data radio bearer (DRB), the enhanced handover being a handover procedure during which the UE maintains communication with a source base station until a connection to the source base station is released after successful handover to a target base station;
perform a random access procedure to the handover target base station;
indicate information from a Medium Access Control (MAC) layer to a Radio Resource Control (RRC) layer upon successful completion of the random access procedure; and
request an uplink path switching from the RRC layer to a Packet Data Convergence Protocol (PDCP) layer for the DRB configured with the enhanced handover when the information from the MAC layer is received.

2. A handover method performed by a User Equipment user equipment (UE), comprising:
receiving an RRC reconfiguration message for instructing an enhanced handover indicating a configuration for a data radio bearer (DRB), the enhanced handover being a handover procedure during which the UE maintains communication with a source base station until a connection to the source base station is released after successful handover to a target base station;
performing a random access procedure to the handover target base station;
indicating information from a Medium Access Control (MAC) layer to a Radio Resource Control (RRC) layer upon successful completion of the random access procedure; and
requesting an uplink path switching from the RRC layer to a Packet Data Convergence Protocol (PDCP) layer for the DRB configured with the enhanced handover when the information from the MAC layer is received.

3. The UE according to claim 1, wherein the processor is further configured to perform retransmission of all PDCP service data units (SDUs) in ascending order of count (COUNT) values associated to the PDCP SDUs prior to the uplink path switching, starting from the first PDCP SDU that has not been confirmed to be successfully delivered for acknowledge mode (AM) DRB, by the PDCP layer, when the request from the RRC layer is received.

4. The handover method performed by the UE according to claim 2, further comprising performing retransmission of all PDCP service data units (SDUs) in ascending order of count (COUNT) values associated to the PDCP SDUs prior to the uplink path switching, starting from the first PDCP SDU that has not been confirmed to be successfully delivered for acknowledge mode (AM) DRB, by the PDCP layer, when the request from the RRC layer is received.
